(19) United States
(12) Patent Application Publication
(10) Pub. No.: US 2004/0096287 A1
(43) Pub. Date: May 20, 2004

(54) PORTABLE DEVICE AND METHOD FOR BEVELING PIPES

(76) Inventor: Jeffrey Lynn Woodrum, North Vernon, IN (US)

Correspondence Address: JEFFREY L. WOODRUM, 39 NORRIS AVENUE, NORTH VERNON, IN, 47265, US

(21) Appl. No.: 10/294,280

(22) Filed: Nov. 14, 2002

(51) Int. Cl. B23C 1/20

(52) U.S. Cl. 409/180

(57) ABSTRACT

A portable device designed to cut bevels on pipe ends, and a method for cutting bevels on pipe ends.

### CROSS-REFERENCE TO RELATED APPLICATIONS

Not Applicable

### STATEMENT REGARDING FEDERALLY SPONSORED RESEARCH/DEVELOPMENT

The present invention does not involve any form of federally sponsored research or development.

### BACKGROUND OF THE INVENTION

The present invention comprises a portable device for beveling pipe ends. It is directed to answer a need for an effective means to bevel pipe ends on job sites during construction and repair work. Although pipes with beveled ends are available from various manufacturers, it is often required that the pipes be cut to size in the field. To facilitate joining these cut pipes together, it is often necessary to cut a bevel on the cut pipe ends.

Various designs of pipe beveling devices are known in the art, each with its own disadvantages. It is the object of the present invention to improve on the known pipe beveler designs.

One variety of beveler devices employs a central mandrel that is inserted into the pipe to be beveled. A cutting means, located on the exterior of the pipe is, while held rotationally in place by the mandrel, rotated around the outer surface of the pipe end to cut the desired bevel. It is a necessary feature of these types of bevelers that the mandrels are of a set diameter adapted to fit the size of pipe to be beveled. Examples of this type of beveler can be found in U.S. Pat. Nos. 3,636,803 granted to Miller and 3,699,828 granted to Piatek.

Other inventors seeking to solve the problems related to mandrel-type devices have employed guide wheels. U.S. Pat. No. 4,180,358, granted to Uribe discloses a power tool attachment employing three (3) guide wheels attached to a faceplate. A power tool cutting bit extends through the faceplate. The bit is flanked by two guide wheels positioned to contact the outer surface of a pipe to be beveled. The third wheel is positioned to contact the inner circumference surface of the pipe opposite the position of the bit. In use, the wheels are rolled along the circumference of the pipe, holding the bit in its relative position to the wheels, the bit cutting the desired bevel as it travels guided by the three wheels.

U.S. Pat. No. 4,517,857 to Fuminier is directed to a method and apparatus for cutting a cast iron pipe. This device and method employ a guide wheel configuration similar to the Uribe device with two (2) wheels located on the exterior surface of a pipe to be cut and one (1) guide wheel on the interior surface of the same pipe.

U.S. Pat. No. 4,682,919 to Mitchell is directed to a portable pipe working machine. The cutting means employed by this device is guided by a carriage and adjustable link assembly, including wheels, movable about the periphery of a pipe to be cut. All wheels are located on the exterior of the pipe.

U.S. Pat. No. 5,393,176 to Waring is directed to a tube beveling machine with adjustable head. In use, a hydraulic clamping mechanism holds a section of pipe in a position to allow contact with a cutting blade.

The present invention employs neither a mandrel nor external guide wheels. It has been determined that guide wheels located within and contacting the inner circumferential surface of a pipe allows better control of a beveling device, therefore allowing a smoother bevel be cut. This configuration allows for even rotation of a cutting means around the circumference of the pipe. Similarly, locating guide wheels at diametrical, or at least wide distances from each other relative to a pipe circumference, improves smooth rotation of the cutting means.

### BRIEF SUMMARY OF THE INVENTION

It is an object of the present invention to provide a device and method for cutting bevels on pipe ends. The disclosed invention and method achieve this objective by providing a means to effectively guide a powered cutting means around the circumference of a pipe and allowing adequate control of the cutting means. This control is provided by a system of guides, including an upper guide and a lower guide, mounted to a frame. In use the upper guide holds the cutting means at a desired position relative to a pipe to be beveled. Both the upper guide and the lower guide contact an inner circumferential surface of the pipe. The lower guide, while in contact with the inner circumferential surface of the pipe, keeps the upper guide in contact with an opposite, or nearly opposite side of the inner circumferential surface of the pipe, thus allowing rotation in an even motion as a user rotates the device so as to cut a bevel around the circumference of the pipe. A desired angle of the cutting means is maintained by a power tool attachment means attached to the frame.

### BRIEF DESCRIPTION OF THE DRAWINGS

FIG. 1 is a bottom view of the frame.

FIG. 2 is a lateral view of the invention.

FIG. 3 is a bottom view of the lower guide.

FIG. 4 is a lateral view of the lower guide, showing one lower guide axle, corresponding lower guide wheel, and a portion of the frame.

FIG. 5 is a bottom view of the upper guide.

FIG. 6 is a lateral view of the upper guide, including upper guide axle and corresponding upper guide wheel.

FIG. 7 is a bottom view of the power tool attachment means, shown adapted for use with a power tool that is operated using alternating current.

FIG. 8 is a bottom view of the power tool attachment means, shown adapted for use with a power tool that is operated using direct current.

FIG. 9 is a lateral view of the power tool attachment means.

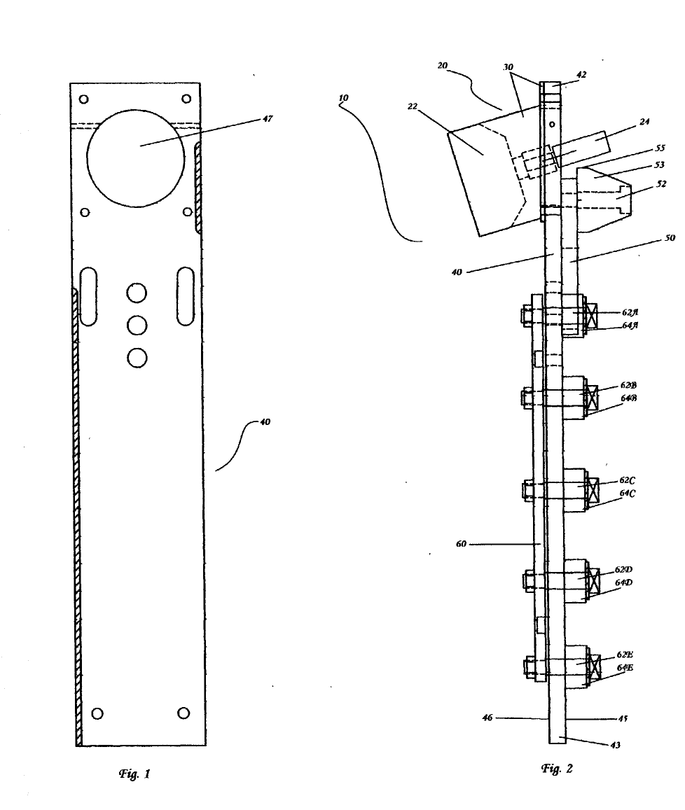

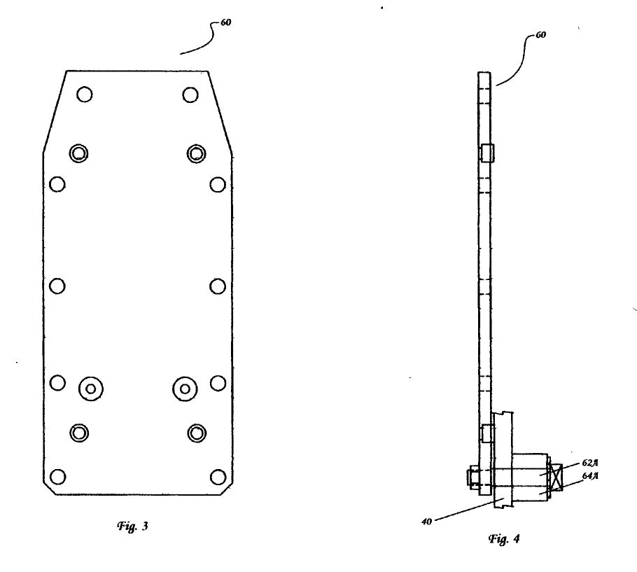

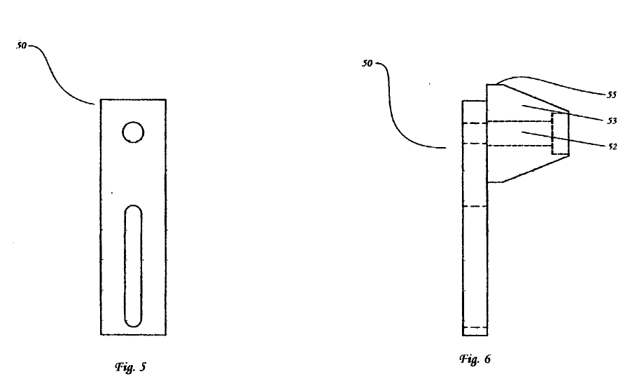

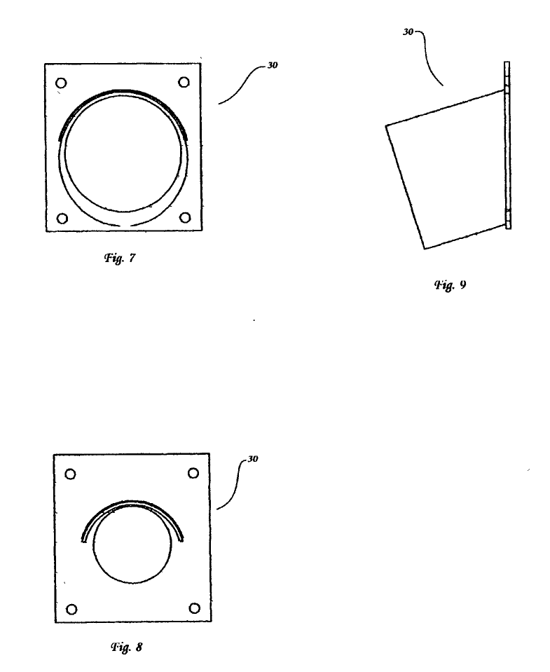

### DETAILED DESCRIPTION OF THE PREFERRED EMBODIMENT

This invention is directed to a portable pipe beveler device 10 and a method for cutting bevels on pipe ends. The device comprises a cutting means 20, a power tool attachment means 30, a frame 40, an upper guide 50, and a lower guide 60.

The cutting means 20 has a power tool portion 22 and a cutter bit 24 attached to the power tool portion 22. In the preferred embodiment, the power tool portion 22 is a rotary-type tool, such as a router, trim router, or cutout tool. A power saw-type tool or other suitable tool can also be used. The cutter bit is a bit adapted for attachment to the power tool portion, for example a router bit or milling bit where a router, trim router, or cutout tool is used, or a saw blade if a power saw is used. A means to adjust the cutter bit depth can be provided to allow a user to cut bevels of differing depths. Further, a means to adjust the cutter bit angle can be provided to allow bevel cuts of differing angles. The power tool portion can be powered by alternating current power sources, direct current power sources, pneumatic drive mechanisms, and any other suitable power sources and systems currently existing and yet to be discovered.

The frame 40 has a first end 42 and a second end 43, and a top side 46 and a bottom side 45. The frame has at least one hole 47 extending between the top side 46 and bottom side 45. The hole 47 is adapted to allow the cutter bit 24 to project through the hole 47. One or more handles attached to the device can be provided to allow a user of the device to hold the device and to facilitate use of the device.

The upper guide 50 is attached to the frame 40. The upper guide 50 need not have an axle and wheel, but ideally can comprise at least one axle 52 and at least one upper guide wheel 53 rotationally attached to the axle 52. The upper guide wheel 53 has an outer circumference surface 55 that is positioned at such a distance from the cutter bit 24 to hold a pipe wall to be beveled against the cutter bit. The upper guide 50 can be movably attached to the frame 40 to accommodate differing pipe wall thicknesses. The upper guide 50 can also be removably attached to allow a different upper guide to be attached when necessary to cut a different type of bevel, for example a bevel on the interior of the pipe rather than the exterior of the pipe. Alternatively, the upper guide can be adapted to allow for cutting a bevel on the interior and the exterior of a pipe.

The lower guide 60 is attached to the frame 40. The lower guide 60 comprises at least one axle 62A and at least one lower guide wheel 64A rotationally attached to the axle 62A. The lower guide wheel 64A is positioned at a discreet distance from the upper guide wheel 53 such that when a point on the outer circumference surface 55 of the upper guide wheel 53 is placed in contact with a point on an inner circumferential surface of a pipe the lower guide wheel 64A will contact the inner circumferential surface of the pipe at a position between ninety and two hundred seventy degrees from the point of contact between the upper guide wheel 53 and the inner circumferential surface of the pipe. The lower guide can be spring loaded in order to assure firm contact between the upper guide and the inner circumferential surface of the pipe, and between the lower guide and the inner circumferential surface of the pipe.

A plurality of axles 62A, 62B, 62C, 62D, 62E and a corresponding plurality of lower guide wheels 64A, 64B, 64C, 64D, 64E can be provided. Each lower guide wheel, for example 64A, can be rotationally attached to a corresponding axle, for example 62A, of the plurality of axles, the lower guide wheels each positioned at discreet distances from the upper guide wheel 53 such that when a point in the outer circumference surface 55 of the upper guide wheel 53 is placed in contact with a point on an inner circumferential surface of a pipe at least one of the plurality of lower guide wheels 64A, 64B, 64C, 64D, 64E will contact the inner circumferential surface of the pipe in a position between ninety and two hundred seventy degrees from the point of contact between the upper guide wheel 53 and the inner circumferential surface of the pipe. Each lower guide wheel 64A, 64B, 64C, 64D, 64E can be placed at distances from the upper guide wheel 53 to accommodate varying and standard pipe diameters. In a preferred embodiment, at least two (2) lower guide wheels, a first lower guide wheel and a second lower guide wheel, will contact the inner circumferential surface of the pipe. The first lower guide wheel will contact the inner circumferential surface of the pipe at a position between 90 degrees and 180 degrees from the point of contact between the upper guide wheel and the inner circumferential surface of the pipe, and the second lower guide wheel will contact the inner circumferential surface of the pipe at a position between 180 degrees and 270 degrees from the point of contact between the upper guide wheel and the inner circumferential surface of the pipe.

The power tool attachment means 30 is attached to the top side 46 of the first end 42 of the frame 40. The power tool attachment means 30 can be removably attached to the top side 46 of the first end 42 of the frame 40. The power tool portion 22 of the cutting means 20 is attached to the power tool attachment means 30 such that the cutter bit 24 extends through the hole 47 in the frame 40 at an angle suitable for cutting a bevel. The power tool attachment means 30 can be adapted to attach to a power tool that is operated using direct current power, a power tool that is operated using alternating current, and a power tool that is operated using pneumatic drive. Any type of power tool that is capable of cutting a bevel cut is contemplated to be a potential power tool portion 22 of the cutting means 20. The power tool attachment means 30 can be removably attached to the frame 40 to allow switching between power tool attachment means 30 adapted to attach to different power tools.

The device 10 can also be adapted to provide a safety guard attached to the frame. The safety guard can be positioned between the cutter bit 24 and a user of the device.

The invention is also directed at a method of cutting a beveled edge on an end of pipe comprising the following steps:

1. providing a pipe to be beveled, the pipe having an edge, a wall, a circumference, and an inner circumferential surface;

2. providing a pipe beveler, the beveler comprising a frame, an upper guide attached to the frame, a lower guide attached to the frame, a cutting means, the cutting means comprising a power tool portion and a cutter bit, and a power tool attachment means attached to the frame, the power tool attachment means further attached to the power tool portion of the cutting means such that in use the cutter bit is located in a position and angle to cut a desired bevel on the edge of the pipe;

3. positioning the pipe beveler such that both the upper guide and the lower guide are each in contact with the inner circumferential surface of the pipe, the lower guide in a position along the inner circumferential surface of the pipe between ninety degrees and two hundred seventy, degrees from the position where the upper guide contacts the inner circumferential surface of the pipe;

4. powering up the cutting means;

5. rotating the beveler while keeping the upper guide and the lower guide in contact with the inner circumferential surface of the pipe, holding the cutter bit at the proper depth and angle to cut a bevel around the circumference of the pipe.

I claim:

1. A portable pipe beveler device, the device comprising:
a cutting means, the cutting means having a power tool portion and a cutter bit attached to the power tool portion;
a frame, the frame having a first end and a second end, the frame having a length running from the first end to the second end, the frame having a top side and a bottom side, the frame having at least one hole extending between the top side and bottom side;
an upper guide, the upper guide attached to the frame, the upper guide comprising at least one axle and at least one upper guide wheel rotationally attached to the axle, the upper guide wheel having an outer circumference surface, the outer circumference surface being positioned at such a distance from the cutter bit to hold a pipe wall to be beveled against the cutter bit;
a lower guide, the lower guide attached to the frame, the lower guide comprising at least one axle and at least one lower guide wheel rotationally attached to the axle, the lower guide wheel positioned on the frame at a discreet distance from the upper guide wheel such that when a point on the outer circumference surface of the upper guide wheel is placed in contact with a point on an inner circumferential surface of a pipe the lower guide wheel will contact the inner circumferential surface of the pipe at a position between ninety and two hundred seventy degrees from the point of contact between the upper guide wheel and the inner circumferential surface of the pipe; and
a power tool attachment means, the power tool attachment means attached to the top side of the first end of the frame, the power tool portion of the cutting means attached to the power tool attachment means such that the cutter bit extends through the hole in the frame at an angle suitable for cutting a bevel.

2. A device as in claim 1 wherein the power tool attachment means is adapted to attach to a power tool that is operated using direct current power and the power tool portion is a power tool that is operated using direct current power.

3. A device as in claim 1 wherein the power tool attachment means is adapted to attach to a power tool that is operated using alternating current and the power tool portion is a power tool that is operated using alternating current power.

4. A device as in claim 1 wherein the power tool attachment means is adapted to attach to a power tool that is operated using pneumatic drive and the power tool portion is a power tool that is operated using pneumatic drive.

5. A device as in claim 1 wherein the power tool attachment means is removably attached to allow switching between power tool attachment means adapted to attach to different power tools.

6. A device as in claim 1 further comprising a safety guard attached to the frame, the safety guard being positioned between the cutter bit and a user of the device.

7. A device as in claim 1 wherein the upper guide is movably attached to the frame to accommodate differing pipe wall thicknesses.

8. A device as in claim 1 further comprising a means to adjust the cutter bit position to allow bevel cuts of differing depths.

9. A device as in claim 1 further comprising a means to adjust the cutter bit angle to allow bevel cuts of differing angles.

10. A device as in claim 1 wherein the power tool portion comprises a rotary tool.

11. A device as in claim 1 wherein the power tool portion comprises a saw.

12. A device as in claim 1 further comprising at least one handle attached to the frame.

13. A device as in claim 1 wherein the lower guide further comprises a plurality of axles and a corresponding plurality of lower guide wheels, each lower guide wheel rotationally attached to a corresponding axle of the plurality of axles, the lower guide wheels each positioned at discreet distances from the upper guide wheel such that when a point in the outer circumference surface of the upper guide wheel is placed in contact with a point on an inner circumferential surface of a pipe at least one of the plurality of lower guide wheels will contact the inner circumferential surface of the pipe in a position between ninety and two hundred seventy degrees from the point of contact between the upper guide wheel and the inner circumferential surface of the pipe.

14. A device as in claims 1 or 13 wherein the discreet distances between the upper guide wheel and the lower guide wheels are adapted to accommodate inner circumferential distances of pipes of differing sizes and types.

15. A method of cutting a beveled edge on an end of pipe, the method comprising the following steps:
providing a pipe to be beveled, the pipe having an edge, a wall, an outer circumference, and an inner circumferential surface;
providing a pipe beveler, the beveler comprising a frame, an upper guide attached to the frame, a lower guide attached to the frame, a cutting means, the cutting means comprising a power tool portion and a cutter bit, a power tool attachment means attached to the frame, the power tool attachment means further attached to the power tool portion of the cutting means such that in use the cutter bit is located in a position and angle to cut a bevel on the edge of the pipe, and at least one handle attached to the frame;
positioning the pipe beveler such that both the upper guide and the lower guide are each in contact with the inner circumferential surface of the pipe, the lower guide in a position along the inner circumferential surface of the pipe between ninety degrees and two hundred seventy degrees from the position where the upper guide contacts the inner circumferential surface of the pipe;
powering up the cutting means;
rotating the beveler while keeping the upper guide and lower guide in contact with the inner circumferential surface such that the cutter bit cuts a bevel around the outer circumference of the pipe.

16. A portable pipe beveler device, the device comprising:
a cutting means, the cutting means having a power tool portion and a cutter bit attached to the power tool portion;
a frame, the frame having a first end and a second end, the frame having a length running from the first end to the second end, the frame having a top side and a bottom side, the frame having at least one hole extending between the top side and bottom side;
an upper guide, the upper guide attached to the frame, the upper guide being positioned at such a distance from the cutter bit to hold a pipe wall to be beveled against the cutter bit;
a lower guide, the lower guide attached to the frame, the lower guide comprising at least one axle and at least one lower guide wheel rotationally attached to the axle, the lower guide wheel positioned on the lower guide so as to be at a discreet distance from the upper guide such that when a point on the upper guide is placed in contact with a point on an inner circumferential surface of a pipe the lower guide wheel will contact the inner circumferential surface of the pipe at a position between ninety and two hundred seventy degrees from the point of contact between the upper guide and the inner circumferential surface of the pipe; and
a power tool attachment means, the power tool attachment means attached to the top side of the first end of the frame, the power tool portion of the cutting means attached to the power tool attachment means such that the cutter bit extends through the hole in the frame at an angle suitable for cutting a bevel.

17. A device as in claims 1, 13, or 16 wherein the lower guide is movably attached to the frame, the lower guide being spring-loaded so as to provide tension away from the upper guide in a direction parallel to the length of the frame.
